(19) United States
(12) Patent Application Publication
(10) Pub. No.: US 2014/0329450 A1
(43) Pub. Date: Nov. 6, 2014

(54) A/C FLOOR MODE FOR VEHICLE COMFORT

(71) Applicant: FORD GLOBAL TECHNOLOGIES LLC, Dearborn, MI (US)

(72) Inventors: Paul Bryan Hoke, Plymouth, MI (US); Clay Wesley Maranville, Ypsilanti, MI (US)

(73) Assignee: FORD GLOBAL TECHNOLOGIES, LLC, Dearborn, MI (US)

(21) Appl. No.: 13/886,490

(22) Filed: May 3, 2013

(51) Int. Cl. B60H 1/24

(52) U.S. Cl. CPC B60H 1/24
USPC 454/75

(57) ABSTRACT

A system may include a multi-position airflow floor control. The system may further include a climate controller device configured to identify an airflow biasing promoting vehicle occupant comfort by performing operations including: determining by a climate controller of a vehicle, to perform cooling based on cabin temperature exceeding a temperature set-point; identifying an airflow biasing between at least a panel vent and a multi-position airflow floor control based on the cabin temperature and a plurality of set-point offsets; and providing an output to adjust cooling flow between at least the panel vent and the multi-position airflow floor control based on the identified biasing.

### BACKGROUND

A vehicle may include a heating, ventilation and air-conditioning (HVAC) system to provide a desired air temperature within a passenger cabin of a vehicle. The HVAC system may include an electronic automatic temperature control (EATC) module configured to automatically adjust the level of heating and cooling in the vehicle based on information received from vehicle sensors and controllers. However, existing EATC modules and manual user inputs may have issues with providing occupant comfort when performing cooling of a vehicle cabin in hot ambient conditions. For example, EATC modules may attempt to cool vehicle occupants by providing fixed amounts of airflow to occupant's lower body via floor duct openings or with no airflow to the floor. Such approaches may provide for insufficient upper body cooling during hot conditions, or excessive upper body cooling once the vehicle cabin has cooled.

### SUMMARY OF THE INVENTION

An exemplary method may include determining by a vehicle climate controller, to perform cooling based on cabin temperature exceeding a temperature set-point; identifying an airflow biasing between at least a panel vent and a multi-position airflow floor control based on the cabin temperature and a plurality of set-point offsets to the temperature set-point; and providing an output to adjust cooling flow between at least the panel vent and the multi-position airflow floor control based on the identified biasing.

An exemplary climate controller device may be configured to perform operations comprising: determining to perform a climate control function based on at least one vehicle climate sensor input exceeding a predetermined threshold level; identifying an airflow biasing between at least a primary airflow vent and a multi-position airflow control based on the vehicle climate sensor input and a plurality of set-point offsets; and providing an output to adjust airflow between at least the primary airflow vent and the multi-position airflow control based on the identified biasing.

An exemplary system may include a multi-position airflow floor control configured to provide variable amounts of airflow to a floor vent; and a climate controller device configured to identify an airflow biasing promoting vehicle occupant comfort by performing operations including: determining by a climate controller of a vehicle, to perform cooling based on cabin temperature exceeding a temperature set-point; identifying an airflow biasing between at least a panel vent and a multi-position airflow floor control based on the cabin temperature and a plurality of set-point offsets; and providing an output to adjust airflow between at least the panel vent and the multi-position airflow floor control based on the identified biasing.

### BRIEF DESCRIPTION OF THE DRAWINGS

FIG. 1 illustrates an exemplary schematic view of a vehicle climate control system for providing vehicle occupant comfort.

FIG. 2 illustrates an exemplary block diagram of a control system of a vehicle climate control system utilizing comfort heuristics for implementing an HVAC strategy accounting for occupant comfort.

FIG. 3 illustrates an exemplary process for implementing an HVAC strategy in a vehicle climate control system accounting for occupant comfort.

### DETAILED DESCRIPTION

HVAC settings appropriate to provide thermal comfort to vehicle occupants may be driven by various factors, and may differ in extreme environments as compared to more neutral environments. In extreme environments, for example upon entering a vehicle after a prolonged soak in a sunny summer condition, relative comfort may be obtained by providing a higher heat transfer to the head and chest or abdomen of a vehicle occupant. This may be accomplished, for instance, by way of high speed dehumidified airflow through panel vents. Once a relative level of comfort has been obtained, a lower speed of airflow directed toward additional areas of an occupant's body may help maintain a uniform thermal environment, and result in better stabilized comfort than continuing to direct substantially all airflow to an occupant's upper body.

An improved controller of an EATC system may be configured to identify a high cabin temperature, and engage maximum A/C cooling mode with airflow directed through panel vents. As cabin temperature cools, the controller may be further configured to selectively redirect or bias progressively more of the airflow from the panel vents to floor or other vents, thereby providing a more uniform thermal environment for the vehicle occupants. The controller may be further configured to bias airflow based on additional factors, such as sunload, vehicle cabin temperature variances or vehicle occupancy.

In some examples, the controller may compare cabin temperature to a plurality of threshold temperature values (e.g., offsets above an A/C-on set point), and may determine an amount of biasing of the airflow from panel vents to floor or other vents based on the determination. Due to differences between vehicle (e.g., ratio of glass to body panels, tinted glass affecting sunload, or headrests in different orientations that affect vehicle) the threshold offset values may be assigned or calibrated according to vehicle type or model. In some cases, the thresholds may be configured according to user preferences, or adjusted based on one or more of the sunload, temperature variances or occupancy factors.

To provide for the identified changes in biased airflow, various types of vents may be utilized. As one example, a multi-position airflow control may provide variable amounts of airflow to a floor vent to selectively provide greater amounts of airflow as the passenger cabin cools, thereby directing airflow away from the panel vents or other airflow zones.

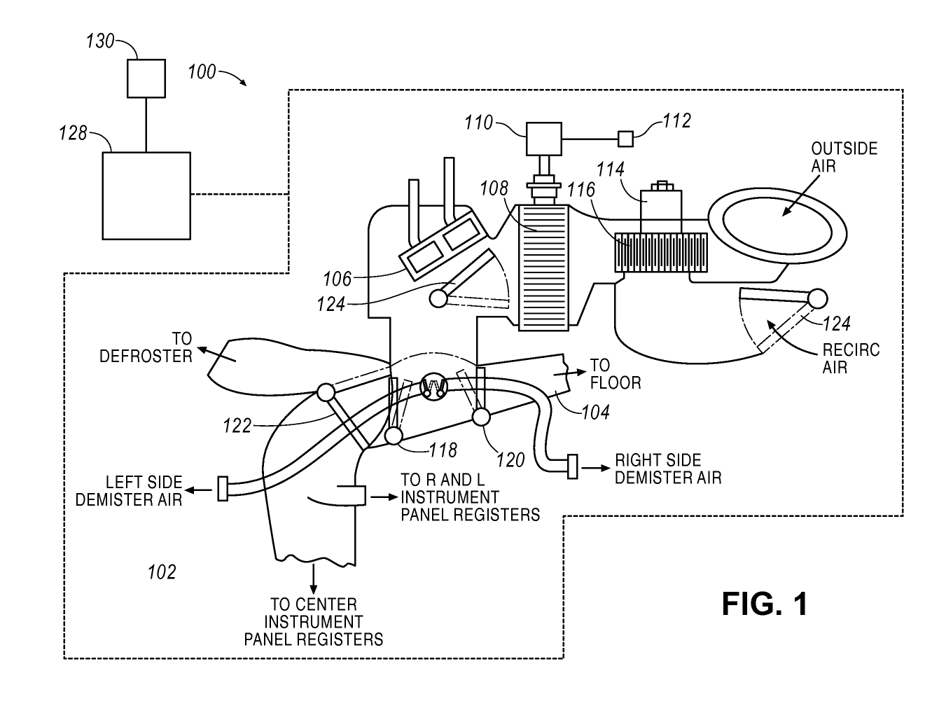

FIG. 1 illustrates an exemplary schematic view of a vehicle climate control system 100 for providing vehicle occupant comfort. The vehicle climate control system 100 may include air processing components configured to heat, cool, and otherwise process air according to a HVAC control strategy. The system 100 may further include air distribution components configured to direct the processed airflow throughout the passenger cabin 102 of the vehicle by way of associated ducting 104.

The air processing components may include heating components, such as a heater core 106, and A/C components such as an evaporator core 108 and a compressor 110 (e.g., a variable displacement compressor 110, a fixed displacement compressor 110, etc.). In some instances, the compressor 110 may be electrically driven, while in other instances the compressor 110 may be mechanically driven by a vehicle engine. The A/C components of the system 100 may also include a low-pressure cycle switch 112 in communication with the compressor 110 operable to deactivate the compressor 110 under certain conditions, such as when the temperature of the evaporator core 108 drops below a predetermined value. This deactivation of the compressor 110 may be performed to aid in the prevention of freezing of the evaporator core 108 in cold conditions. The system 100 may also include fan components including, for example, a HVAC blower 114 and blower wheel 116 for generating airflow of the air being processed.

To control the distribution of the airflow through the ducting 104, the air distribution components may include an arrangement of airflow controls including, for example, a panel door 118 facilitating the selective direction of airflow to the panel vents, a floor door 120 facilitating the selective direction of airflow to the floor vents, a defroster door 122 facilitating the selective direction of airflow to the defroster vents, and an outside recirculated air door 124 facilitating the selection of passenger cabin 102 or outside air as input to the HVAC system. A temperature control blend door 126 may also be included to provide for hot air mixing to obtain a desired target discharge air temperature to be exited from the system 100 into the passenger cabin 102. To facilitate the selective distribution of air, one or more of the doors 118, 120, 122, 124 and 126 may be positioned as open, partially open, or closed.

To provide for the changes in biased airflow to the passenger cabin 102, vents in the vehicle may be controlled by multi-position airflow controls, such as doors, that are configured to selectively provide variable amounts of airflow to various vehicle vents. As one example, one or more of the doors 118, 120, 122, 124 and 126 may be driven by vacuum motors that provide for positioning of the doors according to amount of vacuum, e.g., by using vacuum, partial vacuum and no vacuum positions. As another example, one or more of the doors 118, 120, 122, 124 and 126 may be driven by way of an electric servo motor to facilitate the selective positioning of the doors. The motor may in some cases be stepped down or make use of a feedback system to provide precise angle control to increase the accuracy of door positioning. As yet a further example, a multi-position airflow control may be controlled using multiple position cams. In some examples, each vent may be individually controlled, while in other examples sets of vents (e.g., floor vents, panel vents) may be controlled together.

The system 100 may further include an EATC module such as controller 128 configured to control the operation of the system 100. The controller 128 may be configured to receive inputs from a vehicle occupant via the climate control head 130 to facilitate the occupants of the vehicle in selecting environmental conditions in the vehicle. The climate control head 130 may be included as part of a vehicle instrument panel, and may be configured to allow a vehicle occupant to manually control the HVAC functions, and in some cases, override an automatic operation of the EATC system 100. As some examples, the climate control head 130 may include controls such as: a mode selector configured to allow an occupant to choose where airflow will be directed by the panel-defrost door 118 and floor-panel door 120, a temperature selector configured to allow an occupant to select a preferred cabin air temperature, an A/C control to allow an occupant to manually select or deselect use of the compressor 110, a recirculation selector to allow for control of the recirculated air door 124 to select recirculation of cabin air, fresh air, or some combination thereof, and a fan selector configured to allow an occupant to choose fan speed settings for the HVAC blower 114 and blower wheel 116.

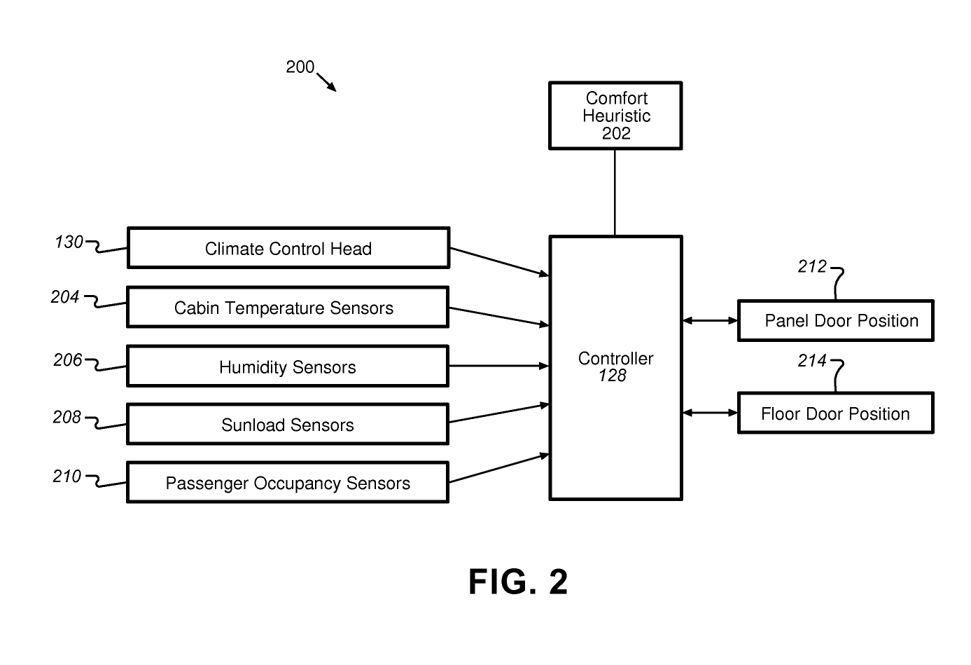

FIG. 2 illustrates an exemplary block diagram of a control system 200 of a vehicle climate control system 100 utilizing comfort heuristics 202 for implementing an HVAC strategy accounting for occupant comfort. The controller 128 of the exemplary control system 200 may be configured to utilize comfort heuristics 202 to selectively bias airflow in the passenger cabin 102 to various areas of the vehicle occupants to facilitate occupant comfort.

The controller 128 may be configured to receive various inputs to inform the comfort heuristics 202 with respect to vehicle or occupant conditions. As some examples, the controller 128 may receive inputs from: cabin temperature sensors 204 (e.g., one or more aspirated thermistors) configured to provide information representative of interior cabin temperature, humidity sensors 206 configured to provide information representative of the relative humidity of the passenger cabin, sun-load sensors 208 configured to utilize photodiodes or other elements to provide information related to sun-loading and direction as it related to various zones of the vehicle, and passenger occupancy sensors 210 configured to provide information related to which seats of the vehicle are occupied.

Based on the received inputs, the controller 128 may utilize the comfort heuristics 202 to determine whether vehicle occupants are experiencing relatively extreme environments or relatively more neutral environments. For example, the controller 128 may identify based on the cabin temperature sensors 204 that the passenger cabin 102 is experiencing hot conditions indicative of extreme environmental conditions. As another example, the controller 128 may identify (or confirm) the extreme environmental conditions based on the inputs received from the humidity sensors 206 and/or sunload sensors 208. If relatively extreme conditions are determined, the controller 128 may utilize the comfort heuristics 202 to selective bias A/C airflow towards vehicle occupant upper body (e.g., by biasing airflow towards the panel vents as compared to other areas such as floor vents). If less extreme conditions are determined, the controller 128 may utilize the comfort heuristics 202 to selective bias A/C airflow towards vehicle occupant upper body but also to other areas of the passenger cabin 102, such by providing an amount of airflow bleed via the floor vents. If relatively normal environmental conditions are detected, then the controller 128 may utilize the comfort heuristics 202 to selective bias the airflow at stabilized levels to various areas of the passenger cabin 102, such as both to panel and also to floor vents.

To provide for the biasing of airflow, the controller 128 may generate one or more outputs. For example, the controller 128 may be configured to provide a panel position output 212 configured to control doors facilitating the selective direction of airflow to the panel vents (e.g., using one or more panel door 118). As another example, the controller 128 may be configured to provide a floor position output 214 configured to control doors facilitating the selective direction of airflow to the floor vents (e.g., using one or more multi-position airflow control floor-panel doors 120).

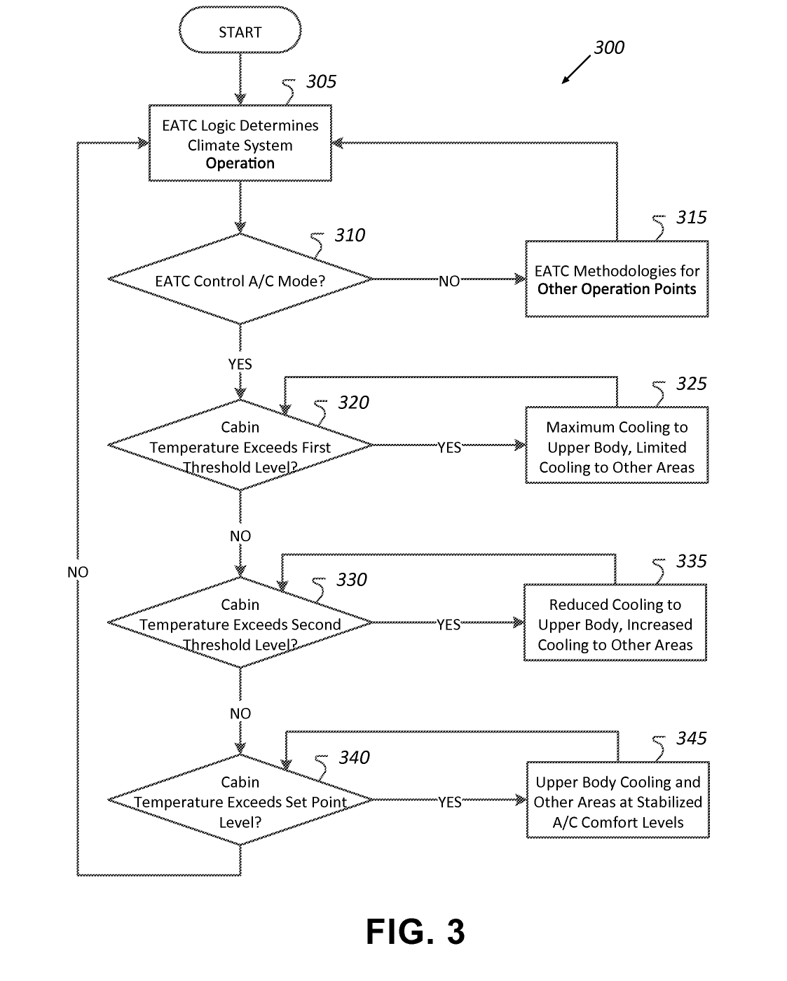

FIG. 3 illustrates an exemplary process 300 for implementing an HVAC strategy in a vehicle climate control system 100 accounting for occupant comfort. The process 300 may be performed by various devices, such as by a controller 128 utilizing the comfort heuristics 202 in combination with the components of the HVAC system 100. By utilizing the comfort heuristics 202, the HVAC control strategy may improve the handling of vehicle occupant comfort in extreme conditions as well as in more stabilized environments.

In block 305, the controller 128 determines the mode of operation of an electronic automatic temperature control system of the vehicle. For example, the controller 128 may determine that electronic automatic temperature control is active according to inputs received from a climate control head 130 of the HVAC system. If EATC is determined to be active, control passes to decision point 310.

In decision point 310, the controller 128 determines whether the electronic automatic temperature control is in an A/C mode. For example, the controller 128 may determine that cooling would be beneficial for occupant comfort, such as according to temperature information received from a cabin temperature sensor 204 (e.g., referred to herein as T_{CABIN}) exceeding a temperature set point (referred to in this example as T_{SET}). If EATC A/C mode is determined to be active (e.g., T_{CABIN}≧T_{SET}), control passes to decision point 320. Otherwise, control passes to block 315, in which the controller 128 may employ EATC methodologies related to other aspects of HVAC operation.

In decision point 320, the controller 128 determines whether cabin temperature is greater than a first offset amount above a temperature set point. For example, the controller 128 may receive temperature information from a cabin temperature sensor 204, and may utilize the comfort heuristics 202 to compare the received value to the sum of the temperature set point and a first offset amount (referred to in this example as V₁). If the controller 128 determines using the comfort heuristics 202 that cabin temperature is greater than the first offset amount above the temperature set point (e.g., T_{CABIN}>(T_{SET}+V₁)), then control passes to block 325. Otherwise, control passes to decision point 330.

In block 325, the controller 128 applies maximum cooling to upper body regions of the vehicle occupants. For example, the controller 128 may be configured to use output 212 to direct all or substantially all of the airflow to panel vents by controlling one or more of the doors 118, 120, 124 and 126. The controller 128 may also provide an output 214 to a multi-position airflow control controlling airflow to a floor vent causing the multi-position airflow control to be closed. After block 325, control may return to decision point 320.

In decision point 330, the controller 128 determines whether cabin temperature is greater than a first offset amount above a temperature set point. For example, the controller 128 may receive temperature information received from a cabin temperature sensor 204, and may utilize the comfort heuristics 202 to compare the received value to the sum of the temperature set point T_{SET} and a second offset amount (referred to in this example as V₂). If the controller 128 determines that cabin temperature is greater than the second offset amount above the temperature set point (e.g., T_{CABIN}>(T_{SET}+V₂)), control passes to block 335. Otherwise, control passes to decision point 340.

In block 335, the controller 128 applies cooling to upper body regions of the vehicle occupants with a portion of floor flow. For example, the controller 128 may be configured to provide an output 212 to direct most but not all of the airflow to panel vents and a small amount of flow to the floor vents. This biasing of a small amount of airflow to floor or other vents may be accomplished by way of controlling one or more multi-position airflow controls selectively providing airflow from the ducting 104. For instance, the controller 128 may provide an output 214 to a multi-position airflow control controlling airflow to a floor vent causing the multi-position airflow control to open to a first open position. After block 335, control may return to decision point 330.

In decision point 340, the controller 128 determines whether cabin temperature is less than the second offset amount above a temperature set point, but at least at the temperature set point. For example, the controller 128 may receive temperature information from the cabin temperature sensor 204, and may utilize the comfort heuristics 202 to identify whether the value is between T_{SET} and T_{SET}+V₂. If the controller 128 determines that cabin temperature is within the aforementioned range, control passes to block 345. Otherwise, control passes to block 305.

In block 345, the controller 128 applies cooling to upper body regions of the vehicle occupants at a stabilized level with an increased portion of floor flow. For example, the controller 128 may be configured to direct a balanced amount of the airflow to panel vents using output 212 and to the floor vents using output 214. This biasing of a small amount of airflow to floor or other vents may be accomplished by way of controlling one or more multi-position airflow controls selectively providing airflow from the ducting 104. For instance, the controller 128 may provide an output 214 to a multi-position airflow control controlling airflow to a floor vent causing the multi-position airflow control to open to a second open position, open greater than the first open position. After block 345, control may return to decision point 340.

Variations on the exemplary process 300 are possible. For example, in addition to biasing airflow between panel vents and other vents such as floor vents, the comfort heuristics 202 may allow the controller 128 to account for sunload on the passenger cabin 102. As one example, the controller 128 may receive information from the sun-load sensors 208 indicative of sun load and direction, and based on the comfort heuristics 202 may further bias the airflow toward the side of the vehicle experiencing more sun load. As another example, in extreme sunload conditions or in high humidity conditions as indicated by information from the humidity sensors 206, the comfort heuristics 202 may adjust the offset amounts (e.g., adjust V₁ and V₂ downward) to maintain relatively higher heat transfer to the head and chest/abdomen of a vehicle occupant airflow for additional time. As yet a further example, the comfort heuristics 202 may cause the controller 128 to account for passenger occupancy in the biasing of airflow. For instance, the controller 128 may receive information from the passenger occupancy sensors 210 indicative of which seats are occupied, and use the comfort heuristics 202 to further bias the airflow toward occupied areas of the vehicle. As an even further example, in examples having multi-position airflow controls with many positions or that freely rotate, the comfort heuristics 202 may use more than two offset amounts, or may compute an airflow control position based on the relation of T_{CABIN} to T_{SET} such that an incrementally smaller interval between T_{CABIN} to T_{SET} incrementally opens up one or more multi-position airflow controls.

As an additional potential variation, a process similar to the process 300 may be utilized for biasing airflow between fogging/defrosting airflow and other vents such as floor vents. In such a variation, the controller 128 may be configured to receive inputs to inform the comfort heuristics 202 with respect to risk assessments of glass fogging or frosting. For example, the controller 128 may identify a risk of formation of ice on the exterior surface of vehicle glass upon receiving input indicative of ambient temperature being below freezing. Or, the controller 128 may identify a risk of condensation forming on the inside surface of the glass upon receiving sensor inputs indicative of a high relative humidity inside the vehicle (e.g., from humidity sensors 206) and cool glass due to a lower temperature outside the vehicle (e.g., from ambient temperature sensors). Yet further, the controller 128 may identify a risk of condensation forming on the outside of the glass if cold air is blown onto the inside of the glass in an attempt to remediate a misting condition. In relatively high risk situations, the comfort heuristics 202 may cause the controller 128 to apply maximum airflow towards the vehicle glass. For example, the controller 128 may be configured to use output 212 to direct all or substantially all of the airflow to defrost vents (e.g., using one or more defroster doors 122). As the risk of fogging, frosting, or condensation is reduced (e.g., by providing dehumidified heated air to the vehicle glass until cabin humidity reaches a threshold value), the comfort heuristics 202 may be configured to cause the controller 128 to bias airflow towards additional areas such as the floor, e.g., by providing an output 214 to a multi-position airflow control controlling airflow to a floor vent causing the multi-position airflow control to open. The controller 128 may accordingly use the comfort heuristics 202 to determine an amount of airflow that may be biased toward the floor to provide hot air to occupant feet in cold weather.

As one example, the controller 128 may utilize the comfort heuristics 202 to provide substantially no airflow to the floor if fogging risk exceeds a first threshold, more airflow to the floor if fogging risk does not exceed the first threshold but does exceed a second lower threshold, and even more airflow to the floor if fogging risk is below the second threshold. As another example, the controller 128 may utilize the comfort heuristics 202 to compute an airflow control position such that an incrementally smaller risk of fogging incrementally opens up one or more multi-position airflow controls to bias airflow from the vehicle glass to other vehicle areas. Thus, once a lowered level of fogging or icing risk has been obtained, biased airflow directed toward areas of an occupant's body may help provide an improved thermal environment for the occupant, and result in better comfort than continuing to direct substantially all airflow to the defrost vents.

Thus, by way of the comfort heuristics 202, the controller 128 may direct the vehicle climate control system 100 to provide thermal comfort to vehicle occupants according to various factors. For instance, the comfort heuristics 202 may cause the controller 128 to provide a higher heat transfer to the head and chest/abdomen of a vehicle occupant, such as by way of high speed dehumidified airflow through panel vents, during relatively extreme heat conditions. Once a relative level of comfort has been obtained, the comfort heuristics 202 may cause the controller 128 to provide a lower speed of airflow directed toward additional areas of an occupant's body, which may help to maintain a uniform thermal environment and result in better stabilized comfort than continuing to direct substantially all airflow to an occupant's upper body.

Computing devices such as the controller 128 generally include computer-executable instructions executable by one or more processors. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor or microprocessor receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computing device). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein. An application configured to perform the operations of the controller 128, such as the comfort heuristics 202, may be one such computer program product and may be provided as hardware or firmware, or combinations of software, hardware and/or firmware.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method, comprising:
determining by a vehicle climate controller, to perform cooling based on cabin temperature exceeding a temperature set-point;
identifying an airflow biasing between at least a panel vent and a multi-position airflow floor control based on the cabin temperature and a plurality of set-point offsets to the temperature set-point; and
providing an output to adjust airflow between at least the panel vent and the multi-position airflow floor control based on the identified biasing.

2. The method of claim 1, further comprising at least one of:
identifying the airflow biasing to provide maximum cooling to operator upper body based on the cabin temperature exceeding a first set-point offset of the plurality of set-point offsets to the temperature set-point;
identifying the airflow biasing to provide reduced cooling to operator upper body and increased floor flow based on the cabin temperature exceeding a second set-point offset of the plurality of set-point offsets to the temperature set-point; and
identifying the airflow biasing to provide stabilized cooling to operator upper body and other vehicle zones based on the cabin temperature exceeding the temperature set-point but not the second set-point offset.

3. The method of claim 1, further comprising identifying the airflow biasing to include a vehicle side biasing according to at least one of: vehicle sunload side differences, vehicle temperature side differences, and vehicle seat occupancy.

4. The method of claim 1, further comprising adjusting at least one of the plurality of set-point offsets according to at least one of: vehicle sunload and vehicle humidity.

5. The method of claim 1, further comprising identifying the plurality of set-point offsets according to at least one of: vehicle type, vehicle model, and operator preferences.

6. The method of claim 1, further comprising adjusting at least one multi-position floor vent in accordance with the identified airflow biasing.

7. The method of claim 1, further comprising identifying the airflow biasing according to received inputs from at least one of: an occupant of the vehicle, a cabin temperature sensor, a cabin relative humidity sensor, and a cabin sun-load sensor.

8. A climate controller device configured to perform operations comprising:
determining to perform a climate control function based on at least one vehicle climate sensor input exceeding a predetermined threshold level;
identifying an airflow biasing between at least a primary airflow vent and a multi-position airflow control based on the vehicle climate sensor input and a plurality of set-point offsets; and
providing an output to adjust airflow between at least the primary airflow vent and the multi-position airflow control based on the identified biasing.

9. The climate controller device of claim 8, wherein the climate control function is vehicle cabin cooling, the at least one vehicle climate sensor input includes a cabin temperate sensor input, the predetermined threshold level includes a temperature set point, the primary airflow vent is a panel vent, and the multi-position airflow control provides airflow to a floor vent.

10. The climate controller device of claim 8, wherein the climate control function includes at least one of vehicle glass defrosting and vehicle glass demisting, the primary airflow vent includes a defroster vent, and the multi-position airflow control provides airflow to a floor vent.

11. The climate controller device of claim 8, further configured to perform operations comprising at least one of:
identifying the airflow biasing to provide maximum cooling to operator upper body based on a cabin temperature exceeding a first set-point offset of the plurality of set-point offsets to a temperature set-point;
identifying the airflow biasing to provide reduced cooling to operator upper body and increased floor flow based on the cabin temperature exceeding a second set-point offset of the plurality of set-point offsets to the temperature set-point; and
identifying the airflow biasing to provide stabilized cooling to operator upper body and other vehicle zones based on the cabin temperature exceeding the temperature set-point but not the second set-point offset.

12. The climate controller device of claim 8, further configured to perform operations comprising identifying the airflow biasing to include a vehicle side biasing according to at least one of: vehicle sunload side differences, vehicle temperature side differences, and vehicle seat occupancy.

13. The climate controller device of claim 8, further configured to perform operations comprising adjusting at least one of the plurality of set-point offsets according to at least one of: vehicle sunload and vehicle humidity.

14. The climate controller device of claim 8, further configured to perform operations comprising identifying the plurality of set-point offsets according to at least one of: vehicle type, vehicle model, and operator preferences.

15. The climate controller device of claim 8, further comprising adjusting at least one multi-position floor vent in accordance with the identified airflow biasing.

16. The climate controller device of claim 8, further configured to perform operations comprising identifying the airflow biasing according to received inputs from at least one of: an occupant of the vehicle, a cabin temperature sensor, a cabin relative humidity sensor, and a cabin sun-load sensor.

17. A system, comprising:
a multi-position airflow floor control configured to provide variable amounts of airflow to a floor vent; and
a climate controller device configured to identify an airflow biasing promoting vehicle occupant comfort by performing operations including:
determining by a climate controller of a vehicle, to perform cooling based on cabin temperature exceeding a temperature set-point;
identifying an airflow biasing between at least a panel vent and a multi-position airflow floor control based on the cabin temperature and a plurality of set-point offsets; and
providing an output to adjust airflow between at least the panel vent and the multi-position airflow floor control based on the identified biasing.

18. The system of claim 17, wherein the climate controller device is further configured to perform operations including at least one of:
identifying the airflow biasing to provide maximum cooling to operator upper body based on the cabin temperature exceeding a first set-point offset of the plurality of set-point offsets to the temperature set-point;
identifying the airflow biasing to provide reduced cooling to operator upper body and increased floor flow based on the cabin temperature exceeding a second set-point offset of the plurality of set-point offsets to the temperature set-point; and
identifying the airflow biasing to provide stabilized cooling to operator upper body and other vehicle zones based on the cabin temperature exceeding the temperature set-point but not the second set-point offset.

19. The system of claim 17, wherein the climate controller device is further configured to perform operations comprising identifying the airflow biasing to include a vehicle side biasing according to at least one of: vehicle sunload side differences, vehicle temperature side differences, and vehicle seat occupancy.

20. The system of claim 17, wherein the climate controller device is further configured to perform operations comprising adjusting at least one of the plurality of set-point offsets according to at least one of: vehicle sunload and vehicle humidity.

21. The system of claim 17, wherein the climate controller device is further configured to perform operations comprising identifying the plurality of set-point offsets according to at least one of: vehicle type, vehicle model, and operator preferences.

22. The system of claim 17, wherein the climate controller device is further configured to perform operations comprising identifying the airflow biasing according to received inputs from at least one of: an occupant of the vehicle, a cabin temperature sensor, a cabin relative humidity sensor, and a cabin sun-load sensor.
